(19) United States
(12) Patent Application Publication
(10) Pub. No.: US 2012/0014820 A1
(43) Pub. Date: Jan. 19, 2012

(54) REPAIRING DEFECTS IN A PIEZOELECTRIC MEMBER

(76) Inventors: Peter Mardilovich, Corvallis, OR (US); Hubert A. Vander Plas, Corvallis, OR (US); Kurt M. Ulmer, Vancouver, WA (US)

(21) Appl. No.: 13/259,409

(22) PCT Filed: Oct. 12, 2009
(86) PCT No.: PCT/US09/60358

§ 371 Date: Sep. 23, 2011

(51) Int. Cl. F04B 17/00; B05D 3/06; B05D 3/02; B05D 5/00

(52) U.S. Cl. 417/410.2; 427/100; 427/510

(57) ABSTRACT

A solution (10) including a solvent and a monomer is coated on an area of a surface (16) of a piezoelectric member (12) such that the solution (10) flows into one or more defects (18). At least some of the solvent is removed to form a monomer film (20) within a defect (18), and the monomer film (20) is polymerized within the defect to form a polymer film (22) within the defect (18).

### BACKGROUND

Inkjet technology has gained wide acceptance as an economical method to dispense small droplets of liquid from a printhead to a desired location. Commonly, piezoelectric inkjet printheads include one or more fluid chambers, engineered to deform during the application of an external voltage. Typically, this deformation decreases the chamber's volume, which causes a droplet of fluid to be ejected through a nozzle at one end of the chamber.

Fluid chambers in inkjet printheads commonly include piezoelectric ceramic materials. Because piezoelectric materials deform in an electric field, an external voltage applied to a piezoelectric material that forms at least part of a fluid chamber may change the chamber's volume and eject a fluid from a nozzle. Fluid chambers may be formed, for example, by attaching a cover plate including one or more piezoelectric actuators to a substrate. Typically, each actuator lies above a fluid channel in the substrate, and includes a fluid-compatible membrane, electrodes, and a piezoelectric material such as lead zirconate titanate (Pb[ZrₓTi₁₋ₓ]O₃ or “PZT”). Commonly, piezoelectric actuators are formed by cutting grooves into a layered piezoelectric/electrode/membrane structure, e.g. with a diamond saw. In an alternative printhead structure, fluid chambers may be formed by directly cutting grooves into a block of piezoelectric ceramic material, placing electrodes within each groove, and attaching a cover plate. In either design, piezoelectric deformation in one channel or region may cause deformation in an adjacent channel or region. This effect, commonly known as crosstalk, may degrade printhead performance.

Piezoelectric ceramics such as PZT may contain defects including voids, pores, and/or cracks. These defects may be generated during synthesis of the piezoelectric ceramic and/or during subsequent machining. For example, a piezoelectric ceramic may contain voids on the order of grain size within the ceramic. Moreover, sawing a piezoelectric ceramic to produce grooves such as those described above may produce cracks including nanocracks (i.e. small cracks or fractures with cross-sectional area typically smaller than 100 nanometers). Defects of any type may increase piezoelectric surface roughness, and may make subsequent processing more difficult. Furthermore, cracks may promote piezoelectric degradation and may grow in size with repeated voltage cycling, and thus may reduce printhead reliability.

### BRIEF DESCRIPTION OF THE DRAWINGS

FIG. 1 depicts a piezoelectric member at various stages of a method of repairing defects in the piezoelectric member according to an embodiment of the invention;

FIG. 2 is an enlarged fragmentary view illustrating flow of a solution into a defect in a piezoelectric member according to an embodiment of the invention, the view being taken generally in the area indicated at 2 in FIG. 1;

FIG. 3 is an enlarged fragmentary view illustrating formation of a monomer film extending into the defect according to an embodiment of the invention, the view being taken generally in the area indicated at 3 in FIG. 1;

FIG. 4 is an enlarged fragmentary view illustrating polymerization of the monomer according to an embodiment of the invention, the view being taken generally in the area indicated at 4 in FIG. 1;

FIG. 5 is a sectional view illustrating an inkjet printhead including a piezoelectric member having a defect repaired in accordance with an embodiment of the invention;

FIG. 6 is an enlarged fragmentary view illustrating a piezoelectric member having a defect repaired in accordance with an embodiment of the invention, the view being taken generally in the area indicated at 6 in FIG. 5.

FIG. 7 is a cross-sectional view illustrating a piezoelectric member having a defect repaired in accordance with an embodiment of the invention, the view being taken generally along a fluid chamber.

### DETAILED DESCRIPTION

The present teachings relate to repairing defects in piezoelectric members. Defects, as used herein, may include imperfections such as voids pores, and cracks. In particular, defects may be nanocracks within grooves cut into the piezoelectric member.

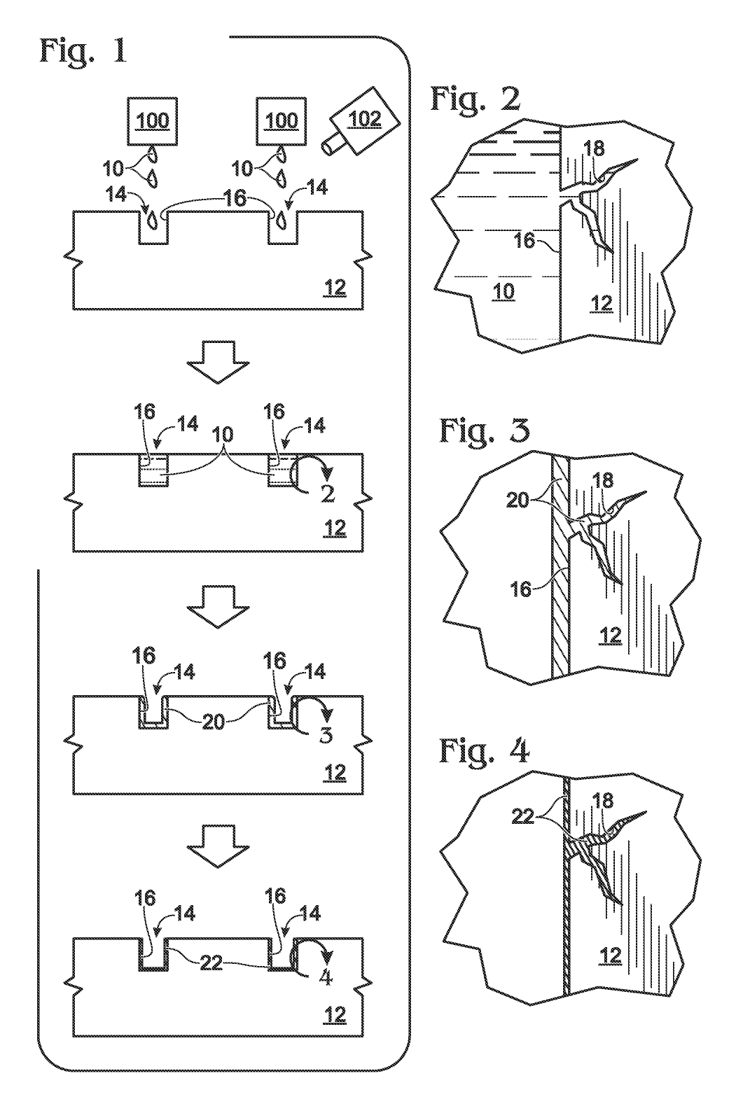

Referring initially to FIGS. 1-4, an exemplary method of repairing defects in a piezoelectric member is illustrated. FIG. 1 demonstrates the exemplary method generally by showing a piezoelectric member through various stages of defect repair. FIGS. 2, 3 and 4 demonstrates the exemplary method more particularly, showing a particular defect through various stages of repair.

In accordance with our teachings, a solution 10 may be prepared for application to a piezoelectric member 12, the solution including a monomer and a solvent. The monomer may include a single monomer species, or may be a mixture of two or more monomer species. Similarly, the solvent may include a single solvent species, or may be a mixture of two or more solvent species. The monomer and solvent may be chosen so that all monomer species dissolve in the solvent to produce solution 10. The monomer species, the solvent, and the concentration of monomer in solution 10 may also be chosen to produce a low viscosity solution, which has low internal resistance and flows readily, and accordingly, may penetrate small defects as will be described further below.

In some embodiments, the monomer may include an acrylic monomer selected from a group including acrylic acid, methacrylic acid, esters of acrylic acid, esters of methacrylic acid, and acrylonitrile. The solvent may be selected from the group including methanol, ethanol, isopropyl alcohol, and water. In particular, a low viscosity solution (e.g., a solution having a viscosity less than 20 centipoise) may be obtained by dissolving acrylic acid in methanol, where methanol is greater than 25% of the solution by volume.

The monomer and solvent may further be chosen to produce a solution that has a contact angle on the surface of less than ninety degrees. A low contact angle is a measure of adhesion between the surface and the solution, and thus the degree to which the solution will spread across the surface during coating. In general, a solution that has a low contact angle (e.g., less than ninety degrees) may more readily spread across the piezoelectric surface and penetrate small defects in the surface as compared to a solution with a relatively higher contact angle. In some embodiments, solutions with a contact angle of approximately 20 degrees or less have been found to sufficiently penetrate cracks (such as those formed upon cutting grooves into the piezoelectric member) to allow repair in accordance with the method described herein.

Turning now to a description of piezoelectric member 12, it will be appreciated that the piezoelectric member may be formed from a piezoelectric ceramic material such as lead zirconate titanate (Pb(ZrₓTi₁₋ₓ)O₃ or “PZT”) configured to deform in an electric field. Alternatively, the piezoelectric member may be formed from PZT doped with a small amount of La₂O₃ ((Pb₁₋ₓLaₓ)(Zr_{y}Ti_{1-y})_{1-x/4}O₃ or “PLZT”) or any other suitable piezoelectric material. As indicated, the piezoelectric member may define one or more grooves 14, typically cut into the piezoelectric member using a saw or the like. The grooves may provide separation between deformable actuator regions of the piezoelectric member, and/or may define fluid channels for delivery of fluid through the piezoelectric member.

In some embodiments, grooves 14 define surfaces 16 that may include defects generated during formation of the grooves. One such defect is illustrated generally at 18 in FIGS. 2-4, the defect taking the form of a crack in an interior side wall of the groove. Although an exemplary defect is shown, it will be appreciated that defects may be cracks, pores, or other non-uniformities, and may naturally occur or result from piezoelectric material synthesis or machining operations. It also will be appreciated that although a single defect is shown, the piezoelectric member may include multiple defects, and that such defects may be present on various surfaces of the piezoelectric member.

Referring now particularly to the method illustrated in FIGS. 1-4, it will be appreciated that solution 10 may be printed onto a surface of piezoelectric member 12 using one or more printheads 100. Solution 10 thus may be applied selectively to a damaged area (or areas) of piezoelectric member 12. It will be appreciated, for example, that the interior surfaces of groove 14 may be coated with solution 10 in order to specifically address defects (such as defect 18 on interior surface 16) caused by sawing the grooves. Alternatively, solution 10 may be coated on a surface 16 of piezoelectric member 12, e.g. by spin coating.

The solution also may be dispensed based on detection of particular defects to be repaired. For example, the location of one or more defects may be detected by an optical camera 102, and solution 10 may be dispensed on a location including a defect exceeding a predetermined dimensional criterion. Likewise, solution 10 may be dispensed on a location that meets an alternative or additional criterion such as defect type or defect density, or any other parameter that may be used to determine the desirability of defect repair.

Detecting defects and dispensing of solution 10 may be semi-automated or automated. For example, defects may be detected using an image recognition system and a defect map may be constructed including types of defects and their coordinates. Solution 10 may then be dispensed using a pre-programmed algorithm to determine the appropriate dispense locations from the defect map.

As best shown in FIG. 2, the dispensed solution coats the damaged area of piezoelectric member 12 such that solution 10 flows into defect 18 (e.g., by capillary action). Correspondingly, the monomer dissolved within solution 10 is carried into defect 18. Solution 10 may be dispensed so as to substantially fill defect 18, but not cover the exterior surfaces of piezoelectric member 12, thus conserving the monomer solution.

Some defects, such as nanocracks that result from sawing the piezoelectric member, may be small, irregular, and difficult to fill. Although polymers are generally pliant, flexible and relatively resistant to cracking, and therefore may be considered for defect repair, their typically long chain structures increase solution viscosity and may prevent a polymer solution from flowing into or filling small defects such as nanocracks. Likewise, other high viscosity solutions, as well directional deposition processes such as sputtering or plasma-enhanced chemical vapor deposition, may be unable to repair small or irregular defects. In contrast, monomer solutions may be selected to accommodate flow into such small defects because of the relatively lower viscosity of the monomer solution as compared to an otherwise equivalent polymer solution. As described further below, after the monomer solution flows into a defect, a crack-resistant polymer may be formed within the defect by polymerizing the monomer.

Once solution 10 flows into defect 18, solvent may be substantially removed from the solution so as to form monomer film 20 (shown in FIGS. 1 and 3) on surface 16 and extending into defect 18. Solvent may be removed by heating, by spinning the coated piezoelectric member at high speeds, or by another method. Where the defect is within a groove, such as described herein, removal of the solvent may effectively clear the groove to provide separation between actuator regions of the piezoelectric member, and/or to provide fluid channels for delivery of fluid through the piezoelectric member. In any event, monomer remains within the defect, and may form a thin film (e.g., on the order of a few microns) over the surrounding surface as shown.

As indicated in FIGS. 1 and 4, monomer film 20 may be polymerized to form a polymer film 22 disposed at least partially within defect 18. Polymerization may occur by exposing monomer film to ultraviolet (“UV”) light. For example, monomer film 20 may be exposed to UV light to form an acrylic polymer, defined as a polymer resulting from the polymerization of acrylic acid, methacrylic acid, esters of acrylic acid, esters of methacrylic acid, acrylonitrile, or a mixture thereof. Following UV light exposure, additional solvent may be removed with mild heating. As an alternative to UV polymerization, film 20 may be polymerized by heating the piezoelectric member, and thus heating monomer film 20, for example to approximately 100 degrees to 150 degrees centigrade. However, polymerization via ultraviolet light may be advantageous where approximately 100 degrees to 150 degrees centigrade heating negatively impacts cost, yield, reliability, or another parameter. In any event, polymerization may be performed at a relatively low temperature, generally less than 200 degrees centigrade, and therefore may be integrated into existing manufacturing processes that are sensitive to high temperatures, or manufacturing processes where high temperature heating may require the addition of a piezoelectric repoling step.

As best indicated in FIG. 4, after polymerization, defect 18 will be substantially filled with polymer, thus repairing the defect. The polymer also may form a thin film (e.g., on the order of a few microns) on surface 16 in the area surrounding the repaired defect. Where the defect is within a groove, as described herein, the groove remains clear after polymerization of the monomer film. It thus will be appreciated that by controlling the quantity of monomer solution dispensed in a selected area (e.g., within a groove), it is possible to form a film of sufficient thickness to fill a defect, but maintain advantageous topography of the piezoelectric member.

Furthermore, by polymerizing the monomer film, defects may be left substantially filled with a pliant, flexible material that is relatively resistant to cracking. The flexible material may also deform under compressive stress so any thin film of polymer remaining within the groove will influence crosstalk minimally, if at all. In contrast, solutions that contain the constituent elements of the piezoelectric, for example, Pb (lead), Zr (zirconium), and Ti (titanium) in the case of PZT, may form hard ceramic material within the groove and defect that may be susceptible to cracking and may increase crosstalk. Accordingly, the polymer may provide mechanical stability, resistance to chemical attack, resistance to environmental degradation, and improved surface properties for subsequent processing.

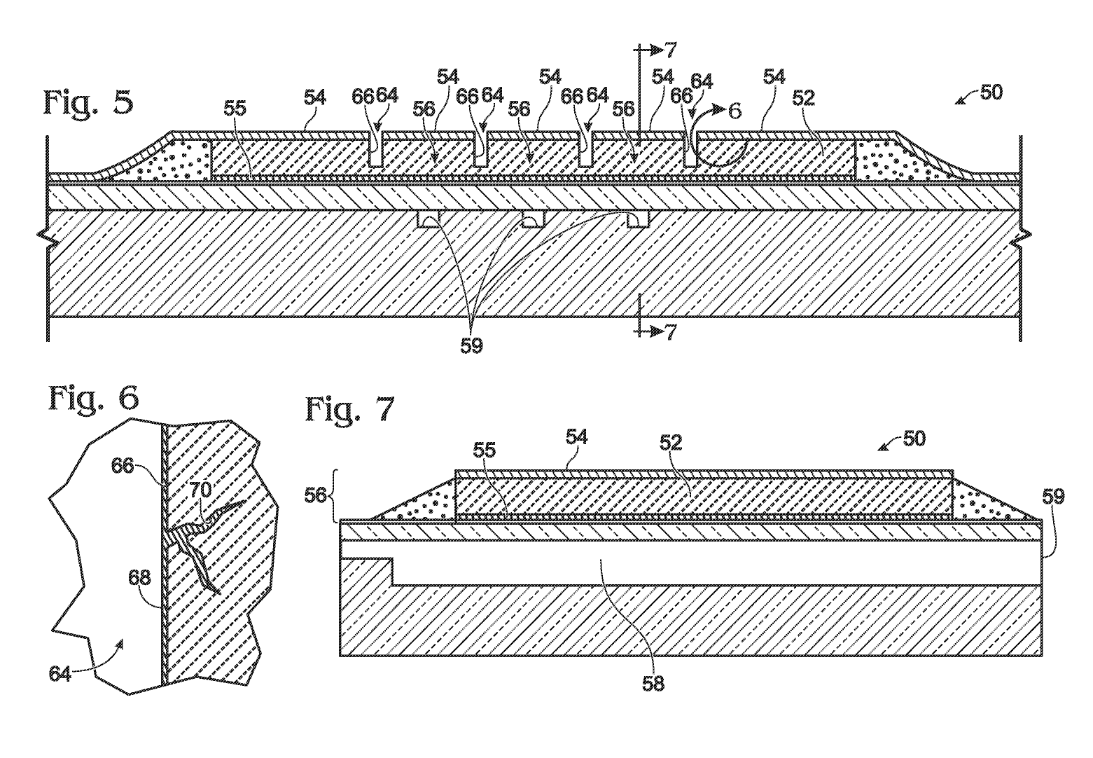

Turning now to FIGS. 5-7, a printhead 50 is depicted, such printhead representing a fluid moving device manufactured using the method illustrated in FIGS. 1-4. Printhead 50 thus will be seen to include a piezoelectric member 52, with one or more actuator regions 56 including a top electrode 54 and bottom electrode 55. Actuator regions 56 are separated by grooves 64 including interior walls 66 and may be disposed above one or more fluid chambers 58. A nozzle 59 may be disposed at one end of each fluid chamber 58. Piezoelectric member 52 also may include other components, e.g. electrical leads (not shown). As shown in FIG. 6, a polymer 68 is disposed within a defect 70, and at least partially coats interior wall 66.

Polymer 68 may be an acrylic polymer, defined as a polymer resulting from the polymerization of acrylic acid, methacrylic acid, esters of acrylic acid, esters of methacrylic acid, acrylonitrile, or a mixture thereof. As indicated, defect 70 may be substantially filled with polymer 68, while polymer 68 does not substantially fill or obstruct grooves 64. Furthermore, defect 70 may be a nanocrack or fracture which results from machining grooves in the piezoelectric ceramic, and polymer 68 may extend substantially the full length of the nanocrack.

What is claimed is:

1. A method of repairing defects in a piezoelectric member (12), comprising:
providing a solution (10) including a solvent and a monomer;
coating an area of a surface (16) of the piezoelectric member (12) with the solution (10), such that the solution (10) flows into one or more defects (18);
removing at least some of the solvent to form a monomer film (20) within a defect (18); and
polymerizing the monomer film (20) within the defect (18) to form a polymer film (22) within the defect (18).

2. The method of claim 1, wherein the monomer includes at least one acrylic monomer selected from acrylic acid, methacrylic acid, esters of acrylic acid, esters of methacrylic acid, and acrylonitrile.

3. The method of claim 1, wherein the solution includes at least one solvent selected from methanol, ethanol, isopropyl alcohol, and water.

4. The method of claim 1, wherein the solution (10) has a viscosity of less than 20 centipoise.

5. The method of claim 1, wherein the solution (10) has a contact angle on the surface (16) of less than ninety degrees.

6. The method of claim 1, wherein coating an area of a surface (16) of the piezoelectric member (12) includes coating an interior surface (16) of a groove (14) formed in the piezoelectric member (12).

7. The method of claim 1, further comprising:
detecting a location of a defect (18) in the piezoelectric member (12); and
determining the area of the surface (16) to be coated with the solution (10) based at least in part on the detected location.

8. The method of claim 1, wherein the defect (18) is a nanocrack, and the solution (10) flows into and substantially fills the nanocrack.

9. The method of claim 1, wherein the monomer is polymerized by ultraviolet light.

10. The method of claim 1, wherein the monomer is polymerized by heating.

11. A fluid moving device (50), comprising:
a piezoelectric member (52) including one or more actuator regions (56);
a groove (64) including interior walls (66) in the piezoelectric member (52); and
a polymer (68) at least partially coating the interior walls (66) of the groove (64), wherein the polymer (68) is at least partially within one or more defects (70) in the interior walls (66).

12. The fluid moving device (50) of claim 11, wherein the groove (64) separates adjacent actuator regions (56).

13. The fluid moving device (50) of claim 11, wherein the polymer (68) is an acrylic polymer.

14. The fluid moving device (50) of claim 11, wherein the defect (70) is substantially filled with the polymer (68).

15. The fluid moving device (50) of claim 11, wherein the defect (70) is a nanocrack, and the polymer (68) extends substantially a full length of the nanocrack.
